(19) United States
(12) Patent Application Publication
(10) Pub. No.: US 2021/0217275 A1
(43) Pub. Date: Jul. 15, 2021

(54) JACKPOT 2.0

(71) Applicants: Noah Francis Carbone, Jupiter, FL (US); Timothy Lee Wright, West Palm Beach, FL (US); Joshua Soren Alderman, Lake Worth, FL (US)

(72) Inventors: Noah Francis Carbone, Jupiter, FL (US); Timothy Lee Wright, West Palm Beach, FL (US); Joshua Soren Alderman, Lake Worth, FL (US)

(73) Assignee: Investment Corporation of Palm Beach, West Palm Beach, FL (US)

(21) Appl. No.: 17/165,049

(22) Filed: Feb. 2, 2021

Related U.S. Application Data
(60) Provisional application No. 62/957,937, filed on Jan. 7, 2020.

(51) Int. Cl. G07F 17/32

(52) U.S. Cl. CPC G07F 17/3258; G07F 17/3293

(57) ABSTRACT

JACKPOT 2.0 is a means of adding an additional jackpot game to any or all card-based casino games of chance. The invention is novel in that it is the only iteration of it's kind proposing a dynamic and operable change to the front face of a standard deck of cards. The invention uses this broadly described change in embodiments that are modified to suit the preferences of casinos or other game providers.

### FIELD

The present invention is in the general field of games of chance and, more particularly, games played with one or more standard decks cards in a casino environment.

### BACKGROUND

Games of chance are played worldwide both in brick-and-mortar casinos as well as on the internet. Many games use one or more standard 52-card decks. As gaming has evolved, players have become more interested in making additional wagers, not based on the direct outcome of the game as originally presented. Rather, jackpots are awarded based on players achieving a pre-determined set of card combinations that vary in difficulty to achieve, as well as monies awarded to winners. These monies awarded are typically known as jackpots. As more and more jackpots are introduced to games, the number of potential variations is restricted due to the limits of the standard decks being utilized in these games of chance.

### SUMMARY

The object of the invention is to add an additional wagering aspect to card games of chance by introducing an additional symbol or element to the standard decks being utilized in said games of chance. By adding an additional symbol or element to front face of standard decks, we create an entirely new wager system that can be added to any and all card-based games of chance.

The number of additional symbols or elements added to the front face of the cards will vary based on the calculated probable outcome preferred by the individual game operators for each game. Decks may be tailored to produce the preferred probable outcome for each individual game of chance.

Players win when they achieve the correct combination of cards with additional symbols or elements added. The game operator may require each player to elect to participate in the additional game before each game (each hand) is played, or operators may choose to increase the scaled commission for individual tables that feature decks with the additional symbols or elements on the front face of the cards.

The method may be employed as a table game, an online table game or in an electronic gaming machine.

### BRIEF DESCRIPTION OF THE DRAWINGS

In the following detailed portion of the present description, the present application will be explained in more detail with reference to the example embodiments shown in the drawings, in which:

FIG. 1 is an example of a standard playing card featuring an additional symbol or element in the form of an example logo, which may be a branded logo for a specific business or property,

FIG. 2 is an example of a standard playing card featuring an additional symbol or element in the form of an example image, which may be a branded image for a specific business or property,

FIG. 3 is an example of 3 standard playing cards featuring an additional symbol or element in the form of a winning combination of letters, in this case “W” “I” and “N”,

FIG. 4 is an example of a generic standard deck where all cards are visible, and featuring additional symbols or elements in the form of a winning combination of letters, in this case “W” “I” “N”,

FIG. 5 is an example of a standard deck where all cards are visible, and features 3 additional symbols or elements,

FIG. 6 is an example of a standard deck where all cards are visible, and features 4 additional symbols or elements,

FIG. 7 is an example of a standard deck where all cards are visible, and features 5 additional symbols or elements.

### DETAILED DESCRIPTION

According to the method of the present invention, a card-based table game player makes an additional wager, or chooses to play on a table featuring an increased scaled commission, in order to play a standard card-based table game with a deck featuring additional symbols or elements added to the front face of the cards. Players will understand that they are playing the standard table game as well as an additional game not based on the outcome of the standard game as originally presented.

A first embodiment of JACKPOT 2.0 is illustrated in FIG. 1, where a standard playing card 100 comprises an indicator of card rank 101 located at the top left and bottom right (inverted) of each card, an Indicator of card suit 102 located beneath the card rank on the top left and bottom right (inverted) of each card, and a corresponding number of pips 103 in the center of the card face that matches the card rank and suit of the card. FIG. 1 part 104 illustrates an additional symbol or element added to the front face of a standard card, and in this case is an example of a generic logo of companies or games providers.

A second embodiment in FIG. 2 features an additional symbol or element presented in the form of an example picture 105 or icon of companies, game providers, or in reference to aspects of popular culture.

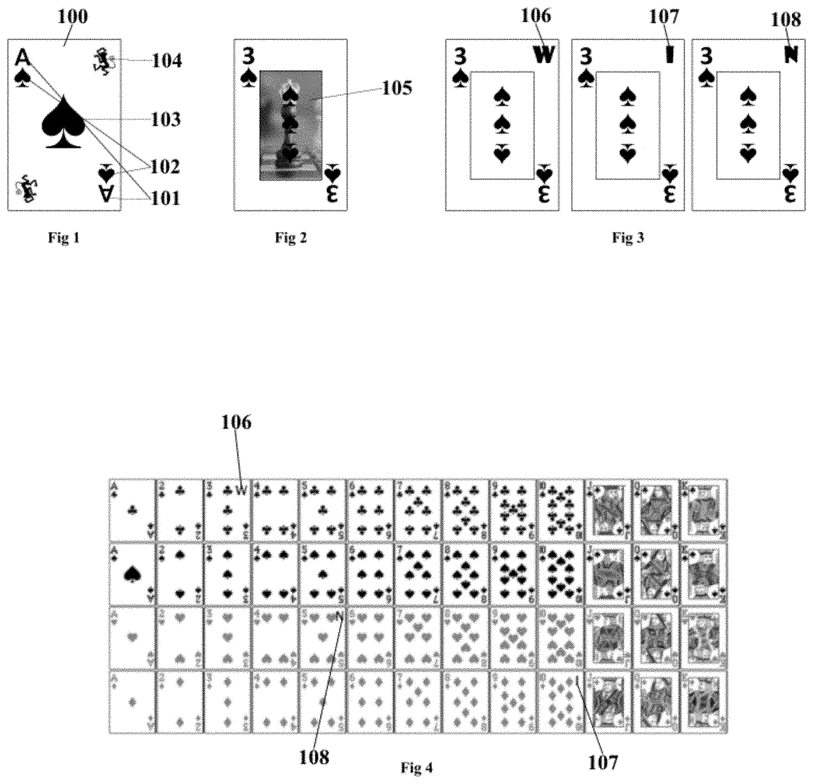

A third embodiment in FIG. 3 illustrates the use of letters as additional symbols or elements which may form a winning combination of letters, in this example “W” 106 “I” 107 “N” 108. This embodiment of JACKPOT 2.0 is reiterated in FIG. 4, which features a winning combination of letters “W” 106 “I” 107 and “N” 108 randomly distributed upon a complete standard deck of cards.

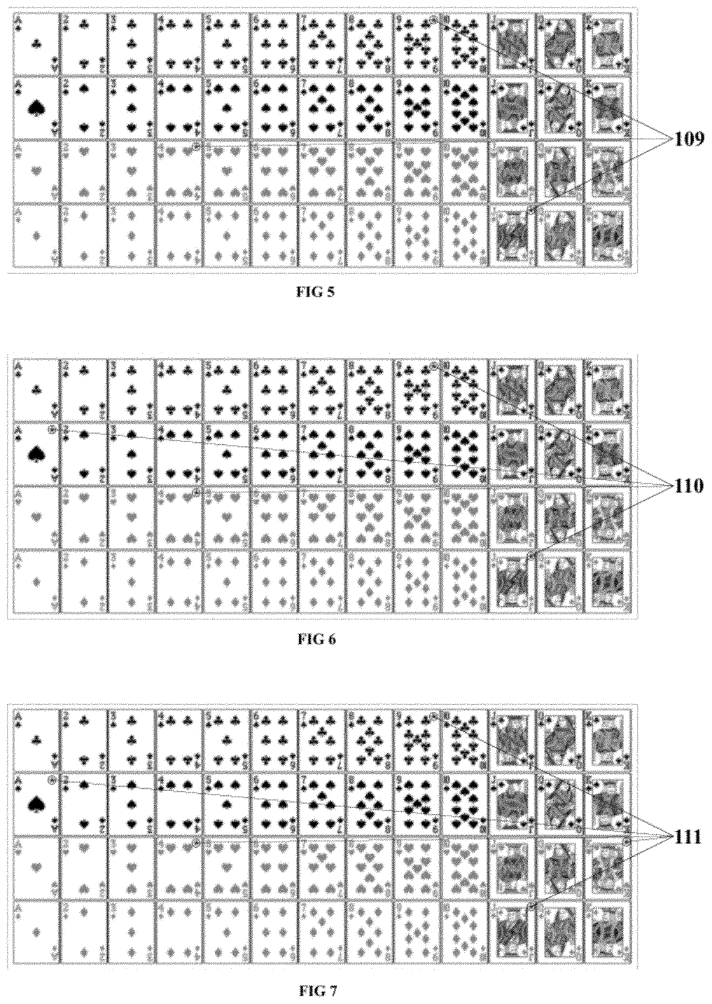

The fourth embodiment in the remaining FIGURES uses the character “*” as an example of a generic additional symbol or element. FIG. 5 illustrates the use of 3 such symbols or elements randomly distributed on the front face of 3 cards of an otherwise standard deck of cards. FIG. 6 uses the character “*” as an example of a generic additional symbol or element and illustrates the use of 4 such symbols or elements randomly distributed on the front face of 4 cards of an otherwise standard deck of cards. FIG. 7 uses the character “*” as an example of a generic additional symbol or element and illustrates the use of 5 such symbols or elements randomly distributed on the front face of 5 cards of an otherwise standard deck of cards.

A standard deck with additional symbols or elements added to the front face of the cards will contain the number of additional symbols or elements tailored to produce the probable outcome of achieving success as preferred by the game operator. For example: In the game of “Three Card Poker” a player receives 3 cards with which they compete against the 3 cards of the “Dealer” or “House” using the standard rules of poker. If 5 cards of the 52 cards in the standard deck have an additional symbol or element on the front face, and the player is required to receive 3 of these cards to achieve success in the additional JACKPOT 2.0 game, the player has an expected winning percentage of 0.045%, or a corresponding probability of ˜2,209 to 1 chance to win. Should the game operator wish to increase or lower these odds, the number of additional symbols or elements may be increased or decreased accordingly.

The method described includes the establishment of probabilities for each individual type of game of chance. The method may also be applied to all games using one or more standard 52-card decks, online games using standard 52-card decks, as well as electronic gaming machines featuring games using standard 52-card decks.

Though the examples shown and described above contain certain embodiments of the present invention, it is to be understood that this invention is subject to modifications without departing from the spirit and scope of the appended claims.

Table modifications may include modifications to the table felts to include an additional betting space for players to opt-in to JACKPOT 2.0, or a promotional image or images indicating the additional JACKPOT 2.0 game has been added to the standard game being played along with an increased scaled commission. Modifications will depend on how the monies will be collected from players wishing to participate in the secondary game as decided by the property offering JACKPOT 2.0.

1. JACKPOT 2.0 consists of the use of 1 or more standard decks of cards used in card-based casino games of chance that features additional symbols or elements added to the front face of a card or cards.

2. JACKPOT 2.0 comprises the use of cards featuring additional symbols or elements added to the front face of a card or cards for which an expected probable outcome frequency may be derived mathematically for each type of card-based casino game of chance.

3. JACKPOT 2.0 may be presented as an opt-in additional game added to a standard card-based casino game of chance, or as a standard card-based casino game of chance featuring an increased scaled commission entering all players who participate.
